(19) United States
(12) Patent Application Publication
(10) Pub. No.: US 2018/0176674 A1
(43) Pub. Date: Jun. 21, 2018

(54) Earbud Capable Of Reassembly

(71) Applicants: Xiuquan Tang, Zhongshan (CN); Chao Peng, Zhongshan (CN)

(72) Inventors: Xiuquan Tang, Zhongshan (CN); Chao Peng, Zhongshan (CN)

(21) Appl. No.: 15/380,820

(22) Filed: Dec. 15, 2016

(51) Int. Cl. H04R 1/10

(52) U.S. Cl. CPC H04R 1/1075; H04R 1/1016; H04R 1/1033

(57) ABSTRACT

An earbud capable of reassembly, the earbud has a speaker construct with a cylindrical body configured with threads that can be screwed together with an adapter sleeve which can be removably mounted to an earbud housing. The earbud also has an ear tip that has internal tubular support for mounting, on the peripheral wall of the tubular support, a protrusion is configured to changed shape when pressed, thereby adjusting the diameter of the ear tip to the size of an ear canal.

### DESCRIPTION OF RELATED ART

The present application relates to an earbud device and more particularly to earbuds that are structured to be capable of reassembly and speaker replacement. The earbuds, also known as earphones, are generally used for handheld electronic devices such as cell phones as well as hearing aids, portable media players and other devices adapted for hearing. The earbuds are provided for enhanced sound isolation and improved feel of comfort to the ears.

Note that the points discussed below may reflect the hindsight gained from the disclosed inventions, and are not necessarily admitted to be prior art.

Earbuds are commonly used for listening to music or phone conversations while walking or running outdoors or inside a workplace while working. They are constructed with a miniature speaker to fit into the ears and are designed as lightweight and independent pieces that are easy to wear in the ears.

However, the current earbud designs have a number of drawbacks, the earbud surface is generally smooth and uniform that does not fit the ear tightly and is often in blocking out ambient environment noises for a user and at the same time ineffective at preventing leakage of the speaker sound into the surrounding area. The ill-fitted earbuds may not be very comfortable to user's ear either. Some users feel discomfort due to the earbuds rigid circular shape which can create too much interference and pressure on the ear. Also the current earbud designs are generally based on a fixed one-piece design, it does not provide any option for changing to a different set of speakers or styles, or for replacing a broken speaker.

A number of designs have been made to improve sound isolation and ear comfort. One attempt is to use a thin foam rubber cover that surrounds the ear phone speaker area. Another attempt is to provide an earphone adapter that includes a sleeve capable of fitting the sidewall of the earbud. Many of the solutions increase manufacturing cost or are cumbersome to use for users.

There is a need for simplified earbud design that provides improved ear comfort and retention, better sound isolation as well as offering higher flexibility for replacement and choices of speakers—an earbud that is capable of being re-assembled with new speaker set and other parts and accessories.

### SUMMARY

The present application discloses new approaches to earbud design that comprise separate and independent parts that allow for reassembly between styles and function choices and speakers as well as with improved ear retention and sound isolation.

In one embodiment, the earbud includes a threaded housing shell and a matching threaded speaker core portion and a cable connection portion for connecting to a sound source, wherein the threaded speaker core portion is fasten to the housing shell through screwing the threads together, and the threaded speaker core portion can be unscrewed from the assembly and replaced with a different one, and new batch of parts can be reassembled together.

In another aspect of the embodiment, the housing shell is structured with an opening that joins with the cable connection portion with a latching mechanism. The housing shell is curved for easy holding by two fingers such as the thumb and the index finger.

In another aspect of the embodiment, the cable connection portion is structured with a coaxial cable connector for connecting video or music cables.

In another embodiment, the speaker core portion is capped with an earbud cap (ear tip) that is designed to provide a cushion layer for the earbud to fit into a human ear canal with comfort. The earbud cap comprises two thinly U-shaped soft silicon layers with the interior layer snapping unto the speaker core portion and the exterior layer shaped to fit into the ear canal.

In another embodiment, the interior layer of the earbud cap includes a flexible ring-shaped protrusion where the flexibility and the softness of silicon material enables the earbud cap to fit into the ear canal comfortably and tightly, thus allowing for improved ear retention and good sound isolation.

The present embodiments of this invention are shown in the following detailed description and drawings. Other variations, such as (but not limited to) the attachment mechanisms of the cable connectors, variation in size, proportion, and inclusion or exclusion of the specific individual features are contemplated and will be recognized from the description of the present embodiments.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1A is a side view of an example earbud embodiment in accordance with this application.

FIG. 1B is a perspective view from the front side of the earbud of FIG. 1A.

FIG. 1C is a perspective view from the back side of the earbud of FIG. 1A.

FIG. 2 is an exploded view of an example earbud embodiment in accordance with this application.

FIG. 3A is a left side view of an example ear tip in accordance with this application.

FIG. 3B is a front view of the ear tip with a section cut-through line 4-4 of FIG. 3A.

FIG. 3C is a perspective view of the ear tip of FIG. 3A.

FIG. 4 is a cross-section view taken along line 4-4 in FIG. 3B.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition. It is contemplated and intended that the design apply to any suitable materials; for clarity reasons, a number of materials are described more specifically but an ordinary person in the art would know the variations to make suitable changes to adopt the design to other suitable materials.

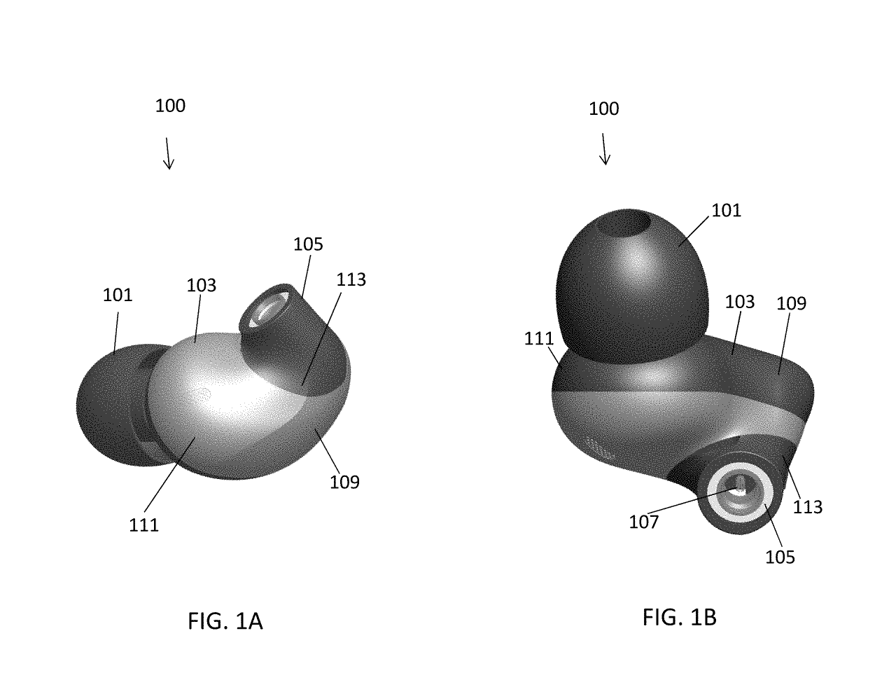

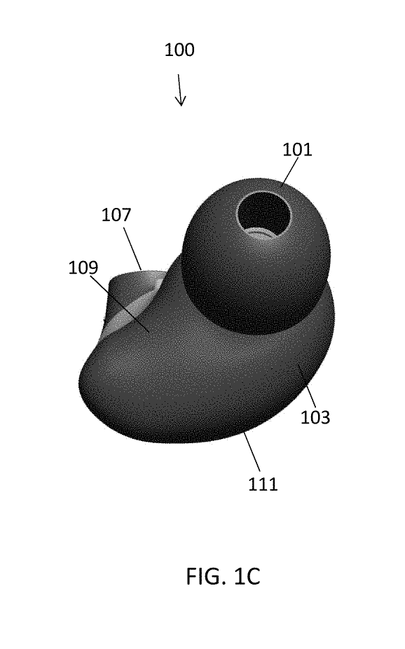

In reference to FIGS. 1A, 1B and 1C, an example reassembly capable earbud 100 is shown from the left side, from the front and from the back side. From the outset, earbud 100 includes three distinctive portions, the earbud cap portion 101, the housing or earbud body portion 103 and the audio cable connector portion 105. The earbud cap 101 designed to press fit over earbud body portion 103, is made integrally, as a single, unitary piece in the semi sphere shape of a winter hat that fits tightly into the canal of the human ear, with an opening and tubular structure in the center to accommodate the speaker of the earbud. The housing or earbud body portion 103 encapsulates a housing space and is smoothly curved like a blunted water droplet (FIGS. 1A and 1C) with a bigger head portion 111 for housing speaker core portion and a smaller rounded tail section 109 for attaching the audio cable connector portion 105. The housing or earbud body portion 103 may be further curved inwardly at its middle section to improve its fitness for holding by two fingers, especially for the thumb and the index finger (FIG. 1B). The audio cable connector portion 105 includes a male coaxial audio cable connector end 107 and a latching head 113 that can be press latched onto housing body 103.

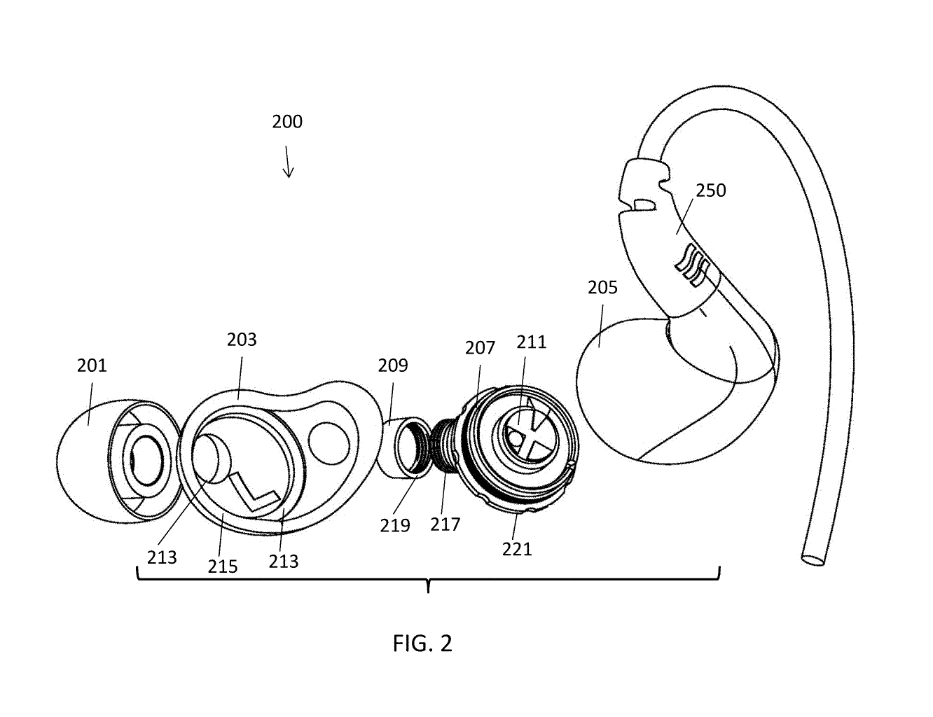

In reference to FIG. 2, an exploded view of an example reassembly capable earbud 200 is shown. The whole design concept is to allow for the entire earbud to be dissembled into several independent parts that can be easily reassembled together for parts replacement and speaker and cable re-combination.

Earbud 200 is dissembled into several independent parts, namely, the ear tip/cap 201, housing body 203, adapter sleeve 209, speaker core 207, and cable connector 205. The housing body 203 is curved like a blunted droplet with shell-like wall constructed to envelope sufficient space to hold the speaker core 207. Inside the enlarged end 215 of the housing body 203, a circular aperture 213 is constructed to allow adapter sleeve 209 to protrude out and to be pressed on with ear tip 201. Adapter sleeve 209 is configured with threads on the interior wall. Speaker core 207 has a speaker section (not shown) built on protrusion 217 with threads configured that can be threaded to adapter sleeve 209. Speaker core portion 207 also includes a tethering ring 221 that fixedly holds the speaker and its electronic part 211 together and tethering ring 221 anchors the whole speaker core 207 to the fitting ring structure 213 inside housing body 203. The cable connector 205 is configured the suitable electronic circuit structure and chips (not shown) for connecting to audio cable 250. The electronic structure will be in contact with speaker electronic structure 211 when the whole earbud is assembled together, by pressing latching onto housing body 203. Pressing latching mechanism is well known in the art, and the exact structure on structure 205 is omitted and any suitable latching into contact such as the one described in U.S. Pat. No. 3,397,001A for closure latches. As shown in FIG. 1B, cable connector 205 may be preferably configured as a coaxial male cable connector that can be plugged with other cable or cable adaptor.

With the threading and the each of the parts can be separated through unlatching and un-screwing from the threads, each of the parts, including speaker, can be replaced and re-assembled. If a user wants to change to a different speaker, he/she can simply dissemble the earbud and replace the old speaker core, and screw on a different speaker core. Through the coaxial cable connector, different audio cables may be used with the earbud through a cable adaptor that can plug into the coaxial cable connector. The size of earbud 200 is preferably slightly larger than a conventional earbud, for example, ranging from 1 cm×1 cm×0.5 cm to 3 cm×3 cm×3; but it can also be produced at any suitable size depends on the purpose of use, and be mounted on an over the head earphone sets.

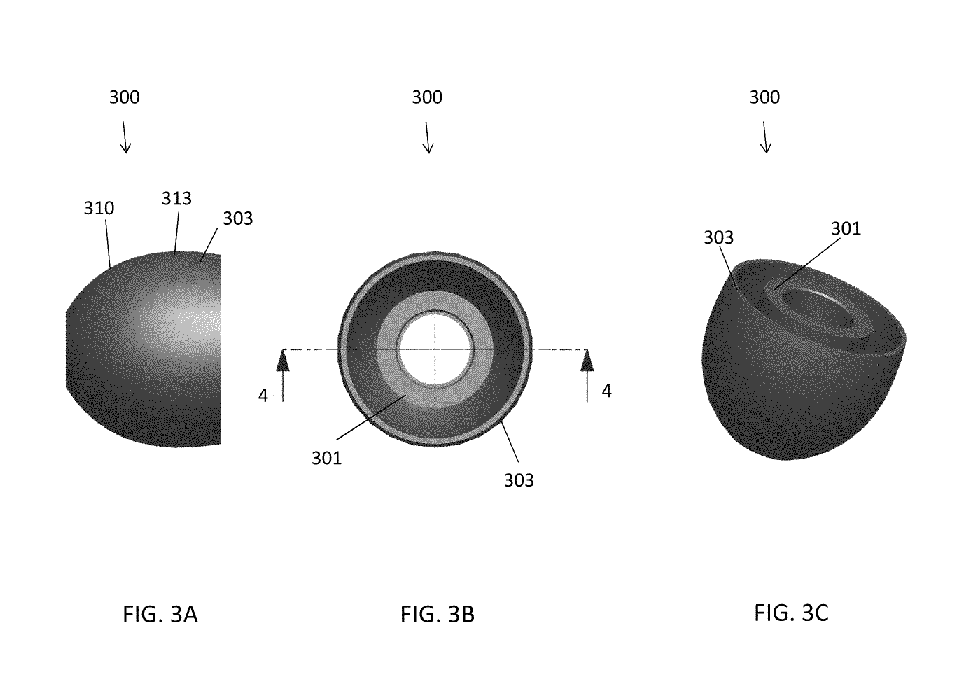

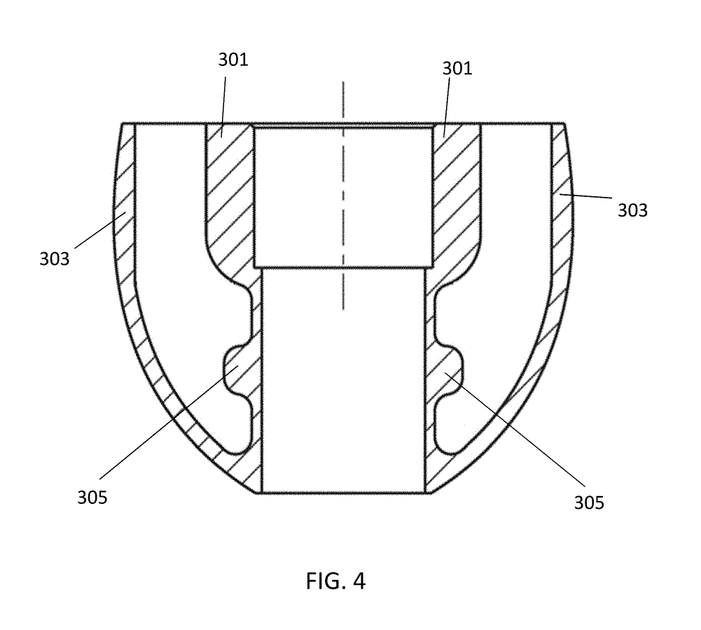

In reference to FIGS. 3 and 4, an example ear tip is described. Ear tip 300 is preferably made of soft silicon. The exterior shape of ear tip 300 is configured with a curved front section 310 for easily press-fitting into a human ear and a tubular section 313 for fitting over the speaker-core protrusion shown in FIG. 2. Structurally, ear tip 300 is constructed as a double-layered structure with a gap between the external layer 303 and the internal layer 301. The front view of ear tip 300 shows two concentric circles as shown in FIG. 3B and FIG. 3C, with the outside circle has a thinner wall than the inner circle.

The cross section structure of ear tip 300 taken alone line 4-4 is shown in FIG. 4. Thin outside layer 303 for comfortable smooth skin feel is shaped like a deep bowl with an opening at the bottom; and inner layer is a tubular structure 301 with thicken wall for attaching onto the speaker core structure. The diameter of inner tubular structure 301 matches to that of sleeve 209 shown in FIG. 2. Inner tubular structure 301 functions as a support and mounting tube that can be press-fit on sleeve 209 to cover the speaker core with smooth soft silicon cap to wear inside an ear canal. In addition, at the middle of the front section to the curved tip, the inner tubular structure 301 is uniquely designed to include a small protrusion 305 that is elastic and changes shape when pressed by pressure. Therefore when the ear tip is pressed into the ear canal, the elasticity of small protrusion 305 will allow protrusion 305 be pressed to change shape in accordance to the pressure being placed on by the ear canal, thus the earbud can adapt to different sizes of ear canals, providing better comfort and better noise blockage and improved prevention of sound leakage from the passage way of the ear. The elasticity of protrusion 305 also provides better retention force for the earbud to stay inside the ear. As the preferred material is soft silicon, other material for the making of ear tip 300 can be silicon rubber and other elastomeric materials. The size of 305 protrusion, which forms a soft protruding ring on inner tube's wall surface facing outside layer 301.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

Additional general background, which helps to show variations and implementations, may be found in the following publications, all of which are hereby incorporated by reference herein for all purposes: US Patent Application No. 2009/0034775 A1 to John E. Burton.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. An earbud capable of reassembly, comprising:
an independent speaker-construct having an body with a speaker-mounted head section and an electronic contact section, wherein said body is configured with a first set of threads;
an independent adapter sleeve having an interior wall surface and an exterior wall surface, said interior wall configured with a second set of threads, wherein said first set of threads screw fit with said second set of threads, mounting said adapter sleeve around said cylindrical body of said speaker-construct;
an independent cable connection-construct for connecting to said electronic contact section of said speaker-construct; and
an independent earbud housing body having a wall enveloping a space housing said speaker portion, said wall having a front-section and a back-section wherein said curved front-section forming an aperture that said adapter sleeve protrudes through to outside said wall, and the wall at the curved end space forming a latching section that joins said cable connection-construct wherein said cable connection-construct is in contact with said electronic contact section of said speaker-construct,
wherein said speaker-construct, said adapter sleeve, said cable connection-construct and said earbud housing body is capable of disassembly and reassembly.

2. The earbud of claim 1, wherein said wall of said earbud housing body is curved in such a way that said front-section is larger than said back section.

3. The earbud of claim 1, wherein said wall of said earbud housing body is curved for thumb and index finger to hold.

4. The earbud of claim 1, further comprising:
an ear tip having a two-layered tubular structure with an round end, comprising an outside cap layer and an inside tubular support layer wherein said cap layer and said inside tubular support layer are merged at said round end and spaced apart, said inside tubular support layer forms a tunnel that is pressed fit onto said adapter sleeve's exterior wall.

5. The earbud of claim 4, wherein said inside tubular support layer has an exterior wall surface facing said outside cap layer, and an interior wall surface forming said tunnel, said exterior wall surface further forms a protrusion around said round end, said protrusion changes shape upon pressing.

6. The earbud of claim 4, wherein said ear tip is made of soft silicon.

7. An independent speaker-construct of an earbud capable of reassembly, comprising:
a speaker-mounted body section and an electronic contact section, wherein said speaker-mounted body section is configured with a first set of threads; and
an independent adapter sleeve having an interior wall surface and an exterior wall surface, said interior wall configured with a second set of threads, wherein said first set of threads screw fit with said second set of threads, mounting said adapter sleeve around said speaker-mounted body of said speaker-construct, and wherein said adapter sleeve is removably installed within said earbud.

8. An ear tip of an earbud, comprising:
a two-layered tubular structure with an round end, comprising an outside cap layer and an inside tubular support layer wherein said cap layer and said inside tubular support layer are merged at said round end and spaced apart, said inside tubular support layer forms a tunnel that is pressed fit onto said adapter sleeve's exterior wall,
wherein said inside tubular support layer has an exterior wall surface facing said outside cap layer, and an interior wall surface forming said tunnel, said exterior wall surface further forms a protrusion around said round end, said protrusion changes shape upon pressing.
